(19) United States
(12) Patent Application Publication
(10) Pub. No.: US 2002/0138706 A1
(43) Pub. Date: Sep. 26, 2002

(54) Reader-writer lock method and system

(75) Inventor: Jean-Christophe Hugly, Palo Alto, CA (US)

Correspondence Address: GARY CARY WARE & FREIDENRICH LLP, 1755 EMBARCADERO ROAD, PALO ALTO, CA, 94303-3340, US

(73) Assignee: Littera, Inc.

(21) Appl. No.: 09/814,347

(22) Filed: Mar. 21, 2001

(51) Int. Cl. G06F 12/14

(52) U.S. Cl. 711/163

(57) ABSTRACT

A method of and a system for resolving memory access conflicts as between a write and one or more reads. This is accomplished by causing a change from the normal read data flow. The change from normal data flow is an exception condition, (an asynchronous or extraordinary or unexpected change in instruction data flow). When the method and system encounter a read-write conflict, and an exception is created, and an exception handler causes the write to occur first, and, upon recovering from the write first exception, restores control to the read.

### BACKGROUND OF THE INVENTION

The invention relates to methods and systems for resolving resource access conflicts as between one exclusive operation (such as writing) and one or more concurrent operations (such as reading), and more particularly to an exception-based access conflict resolution method and system.

Modern information systems are often programmed in such a way that, to the end user, multiple sequential activities seem to take place concurrently. Sometimes this is achieved by actually using multiple processors available on the hardware platform. But most often this is achieved by relying solely on the ability of the operating system, the application program, or both of them working together, to alternate the execution of each task quickly either at regular intervals or when the currently executing task has to wait for some internal system state to change. It is very rare that the interleaving or simultaneity of the execution of two given portions of two activities can be predicted statically, that is, when writing the program rather than when executing it.

At the same time, such information systems may manipulate data objects which are too big or complex to be modified in a single access operation (“atomically”), or where the nature of the modification itself requires more than one access to the data. As a result, during such a modification an object may be materially observed, i.e., read, by one sequential activity while it is in the process of being modified, i.e., written, by another activity.

A common conflict situation is where two sequential activities may attempt to alter the same initial state of an object in contradictory ways. This may result in an invalid state of the object being observed or produced, unless the various sequential activities which share access to this object observe an explicit protocol to prevent a modification sequence from being interleaved or occurring simultaneously with another sequence that requires access to the object. Such a protocol is often called a synchronization protocol, and the objects sought by two or more such activities are often called critical resources. By obtaining access permission to a critical resource according to a synchronization protocol, a sequential activity is said to enter a critical section. By surrendering such permission, a sequential activity is said to leave a critical section.

There are a number of well-known synchronization protocols or mechanisms. One of the most common is known as a “mutex” (mutual exclusion). A mutex is a data object which encapsulates a list of activities waiting for the permission to access a critical resource, and a piece of elementary data which can be modified atomically to signify whether one activity currently has permission to access the critical resource. A protocol such as a mutex is inefficient because it blindly serializes all accesses to the critical resource, whether the accesses are observing it or modifying it. However, in many cases, the data object of the critical resource may be validly observed by many activities simultaneously, as long as the resource is not being modified, or as long as no more than one activity modifies it at any given time.

A commonly known constraint is the “single writer—multiple readers” protocol. The need for such a synchronization protocol has been formalized with solutions proposed by Edsger W. Dijkstra decades ago, along with concepts and algorithms for the mutex and the semaphore. All currently known reader-writer lock implementations are variations of this proposition.

The known Dijkstra implementations involve at least two mutex operations and some counter manipulations for every critical section. This is true whether the thread is a reader or a writer, and whether there is an access conflict or not. Thus, readers carry overhead and have to perform some additional work so that writers cannot be starved. This usually involves an additional mutex and a counter. Readers do a lot of work so that the necessary information is available to a writer which may try to enter while the readers are reading, and so that they synchronize properly with a writer which may already be in the critical section. Using the known Dijkstra protocol, a read operation, which typically occurs frequently, carries as much overhead as an infrequently occurring write operation. This results in such a high overhead cost to readers compared with that of a simple mutex, that it often outweighs the benefits in throughput derived from having the ability to do parallel reads. For this reason many programs use mutexes where a reader-writer lock would otherwise be appropriate. Accordingly, current reader-writer locks are effectively limited to cases where read operations take long enough and are subject to enough parallelism to compensate for the high overhead and inefficiency.

Thus, it is desirable to provide controlled access systems and methods which reduce the overhead carried by frequent readers in seeking access to a critical section, and improve the efficiency of handling access conflicts between readers and writers. It is to these ends that the present invention is directed.

### SUMMARY OF THE INVENTION

As will be described in more detail shortly, the method and system of the invention afford an efficient, fast, low overhead process and system for resolving read-write conflicts by inhibiting a pending write process until all currently queued read process have occurred, thereby avoiding inefficient and slow protocols such as the Dijkstra protocol. The invention establishes a reader counter which is unmodifable when a writer process is active. When a writer process is active, a reader process attempting to modify a reader counter causes an exception. The exception handler then pauses the reader process until the writer process is completed and the reader counter again becomes modifiable.

In accordance with the invention, process synchronization is minimized and conflicts are avoided in a very efficient way. A greater share of the overhead associated with process synchronization and conflict avoidance is carried by the less numerous writers in the system for and method of synchronizing exclusive operations, such as read and write operations. The method and system of the invention operate on an object protected by a lock.

In one aspect, the invention starts with a reader incrementing a counter before reading the object protected by a lock and decrementing the counter when finished reading the object. Unicity or singleness of the writer may be ensured by existing methods, such as a mutex or mutual exclusion object. A writer removes write permission to the counter before writing the object protected by the lock, and sets the counter so that attempts to modify the counter by a reader fail with an exception. In this way a reader is precluded from accessing the object during a write. The writer can write the object if the counter is zero. Otherwise, the writer pauses until any readers reading the object are finished. While the counter is blocked by the writer, a reader attempting to read the object triggers a memory reference exception. This memory reference exception may be captured by an exception handler which causes the reader to wait until the writer is finished. The writer writes to the protected object, and thereafter resets the counter to a writeable state, thereby permitting read access to the object.

The invention advantageously affords a reader-writer lock which minimizes considerably the overhead on the reader and puts more overhead on the writer. The invention recognizes that in memory access situations writing is a relatively rare operation as compared to reading, and associates most of the overhead with writing and conflict resolution. This makes the overhead of a contention-less read operation smaller than that of a mutex. Modern hardware and operating systems provide support for a program to handle certain type of exceptional situations. The invention takes advantage of this support and induces such a situation in readers when a writer wants to write, so that readers discover the exception automatically without the overhead required for explicitly checking for it.

### BRIEF DESCRIPTION OF THE DRAWINGS

FIG. 1 illustrates a client-server system with which the invention may be employed, the figure showing clients connected to a database server through a LAN server;

FIG. 2 is a diagrammatic representation of a first “Reader” process reading a database, followed by a “Writer” process writing to the database, with the “Reader” and “Writer” processes synchronized through the use of container and the exception handlers in accordance with the invention;

FIG. 3 is a flow chart of an exception handler process in accordance with the invention;

FIG. 4 is a flow chart of a normal read process for a critical section illustrating a reader counter being atomically incremented and decremented by the reader process;

FIG. 5 is a flow chart of a read operation when a writer is present; and

FIG. 6 is a flow chart of a read operation when the a writer process seeks to acquire the a read write lock before a reader releases it.

### DESCRIPTION OF PREFERRED EMBODIMENTS

The invention is particularly well adapted to avoiding access conflicts for critical resources such as memory accesses, and will be described in that context. It will be appreciated, however, that this is illustrative of only one utility of the invention, and that the invention may be used for resolving other access conflicts.

As used herein, the following terms having the following meanings:

“Critical section or resource”: A section of instructions or a resource that may be used only by either one writer thread or any number of reader threads at any given time. Here, a resource is an abstract entity which has the meaning for a programmer. In the context of the present invention, the resource is an object protected by a lock and otherwise changeable by a writer process.

“Lock or Reader-Writer Lock”: A logical entity that encapsulates the state of a single particular critical section as managed by algorithms presented here. In programming terms, it is a data structure.

“Acquisition of a lock as a writer or as a reader (by a thread)”: Obtaining permission to use a corresponding critical resource with exclusivity or without exclusivity according to the reader-writer synchronization protocol used.

“Release of a lock”: Surrendering permission to use a corresponding critical resource.

“Counter.” A component or a part of each lock data structure used to keep track of the number of readers allowed to use a corresponding critical resource.

The invention has applicability to any computer system in which different processes attempt to access the same critical resource simultaneously, and especially where one process attempts to change the critical resource. As indicated above, the invention is especially applicable to a reader-writer lock for controlling reads and writes to a memory. The memory may be either a short-term storage memory such as RAM, or a long-term memory such as a database stored on a hard disk. The computer system may be a multiprocessor computer system, or it may be a client-server system having a plurality of individual client computers attempting to access the database through a server. The invention will be described herein in the context of a client-server system.

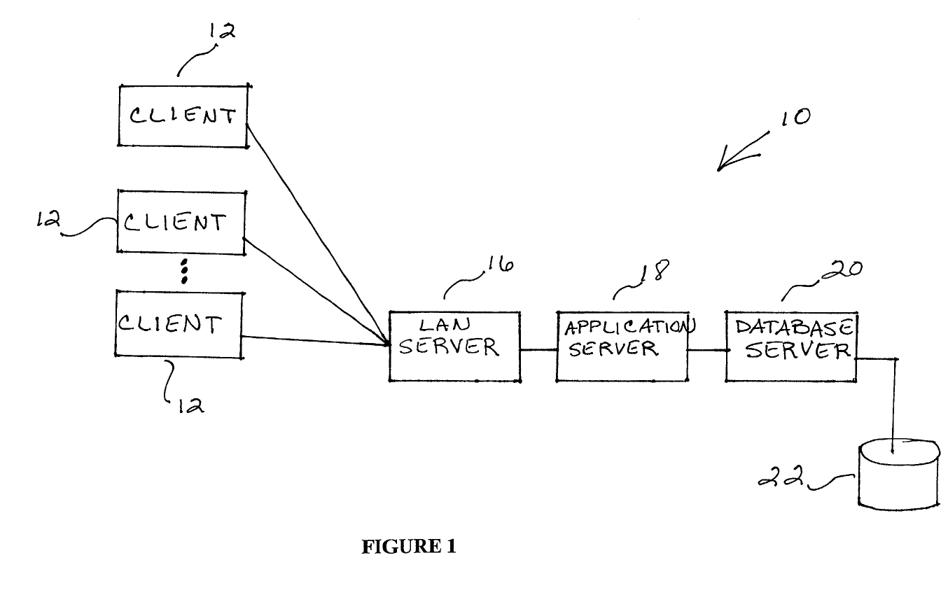

FIG. 1 illustrates a client-server system 10 with which the invention may be employed. As shown, the system may comprise a plurality of clients 12 connected to a LAN server 16, which in turn is connected to an application server 18 and to a database server 20. The database server may provide access to database 22. In a client-server system such as illustrated, one or more clients may be initiating a “read” to the memory, while another client may be initiating a “write.” This initiates the exception handler method of the invention, as will be described below.

While parallel concurrent accesses by clients 12 of the same memory location in the database 22 for reading is permitted and even desirable, as previously explained a conflict exists when a client attempts to write into a memory location while other clients are attempting to read the memory location, or where two or more clients attempt to write the memory simultaneously. Database 22 comprises a critical resource, and simultaneous access by clients for reading and writing presents an access conflict which must be managed. The invention accomplishes this as will be described in more detail below.

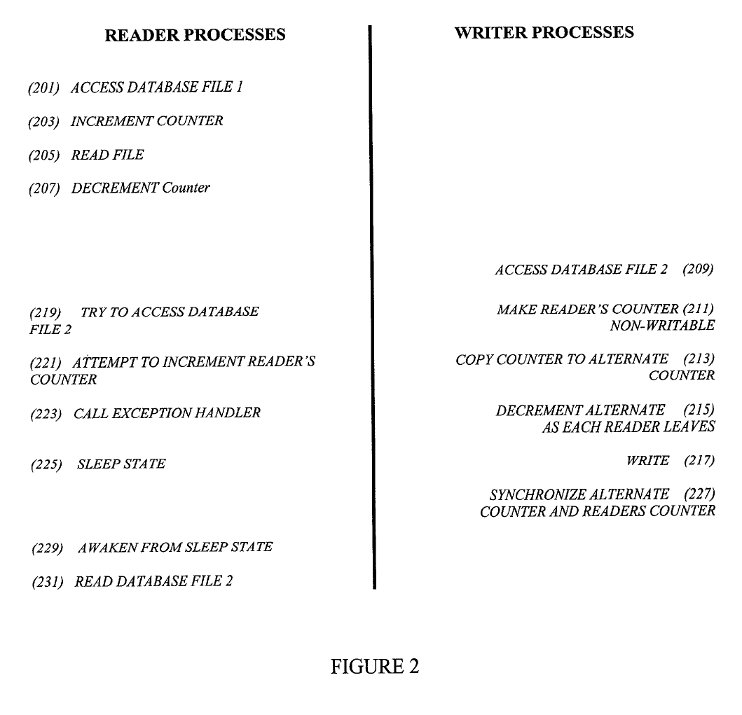

FIG. 2 represents a timeline of a first “Reader” process reading a database, followed by a “Writer” process writing to the database memory, where the “Reader” and “Writer” processes are synchronized through the use of counters and exception handlers described herein. As shown in the timeline of FIG. 2, a reader process accesses a database file, File 1, (201) and increments a reader counter (203). Thereafter, it reads the database File (205). After the reader finishes reading the database File, it decrements the reader counter (207). In this way, the counter maintains a queue of readers accessing the database Meanwhile, upon a writer process accesses database File2 (209) and as part of a write process, the invention makes the reader counter non-writeable, i.e., unmodifiable (211). The contents of the reader's counter are copied to an alternate counter established by the writer in another memory location (213). The alternate counter is decremented as each reader leaves the object (215). When the alternate counter reaches a count of zero, the writer is awakened and given access to the database to perform a write (217). It then wakes up any new readers that may be waiting for access, and synchronizes the read counter with the number of readers new awakened (227).

While the write activity has control of the process during steps 209 to 227 in FIG. 2, an attempt by a reader to access database File2 (219) causes an attempt to increment the reader counter (221). This results in calling the exception handler (223). This puts the reader into a sleep state (225). After the writer completes writing, it awakens the reader (229) and provides access to read the database (231).

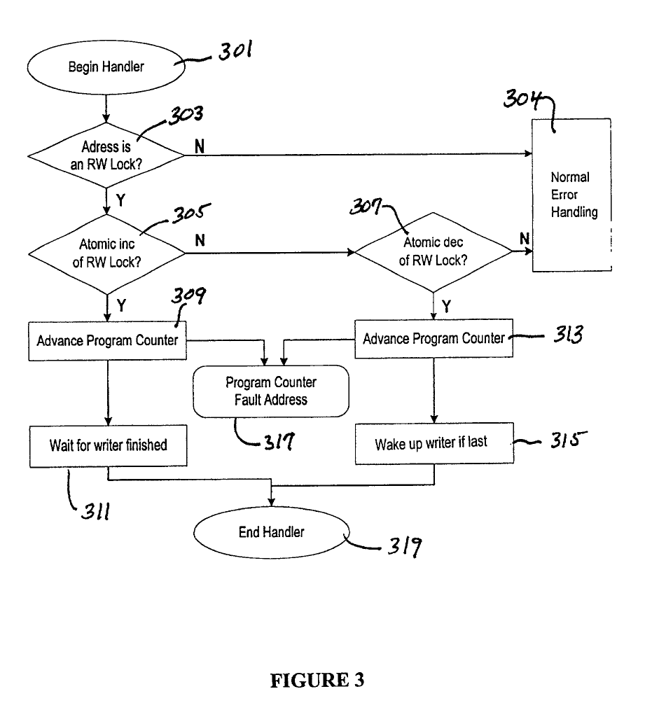

FIG. 3 is a flow chart that illustrates a preferred embodiment of a fault exception handler process and system of the invention. The exception handler process begins at 301 by routine testing to see if the address being accessed is a read/write (RW) lock 303. If it is not, the process goes to a normal exception or error handling routine 304. If, however, the address is a RW lock, a fault occurs and the instruction is tested for an atomic increment or decrement of the RW lock address at 305, 307. If neither an increment or a decrement, normal exception handling is entered (304). If it is either of an increment 305 or a decrement 307, the program counter is advanced, the reader is paused for the writer to finish 311, or is made to wake-up a waiting writer 315, and then the exception handler is finished (319).

FIG. 3 provides an overview of a preferred form of the complete algorithm of the handler. As illustrated in FIG. 3, the handler performs different actions depending on whether the fault-producing instruction is an atomic increment or decrement. First the exception handler determines if the address is a reader-writer (RW) lock (303). If not, a normal exception handler is invoked. If the address is an RW lock and the instruction is an increment (305), then the handler assumes that the intent is to acquire the lock. Otherwise it assumes that the intent is to release the lock. These two operations imply the execution of two different parts of the full-weight synchronization. In addition, advancing the program counter (309, 313) past the increment (305) or decrement (307) instruction may involve different code. It is possible that in some combinations of processor and operating systems, failure to execute the atomic increment or decrement instructions generate two different exceptions to which two different handlers may be connected. Each handler may be specialized in each particular case, making it unnecessary to test explicitly whether the instruction is increment or decrement. After waking up any candidate writer (315), e.g., if the reader is leaving the critical section and an atomic decrement was attempted, and this is the last reader, or after waiting for the current writer to be finished (311), e.g., if the reader is entering the critical section and an atomic increment was attempted, the handler may be exited.

To acquire a lock as a reader, the following steps, represented below as pseudocode, may be used:

Attempt to increment the counter;

If an exception occurs, perform a full weight synchronization;

Execute the critical code;

Attempt to decrement the counter;

If an exception occurs, perform a full weight synchronization.

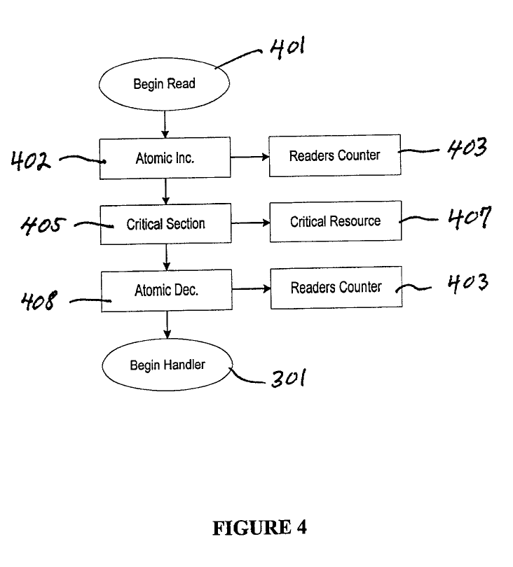

FIG. 4 is a flow chart that illustrates the normal read process for the critical section. The read process begins at 401. The reader counter 403 is atomically incremented 402, and the critical section (405) is entered. The critical resource is operated on (407) and the reader counter is decremented 308 on ending the read process.

FIG. 4 illustrates the normal read access critical section. A normal read is the operation for which this synchronization is optimal and the overhead is limited to the two atomic operations, an increment (305) and a decrement (307). The reader's counter (403) is incremented (305) when the critical section is entered (405) which enables the critical resource to be accessed (407). Following execution of the code in the critical section, the reader's counter (403) is then decremented. The exception handler is not involved in this process.

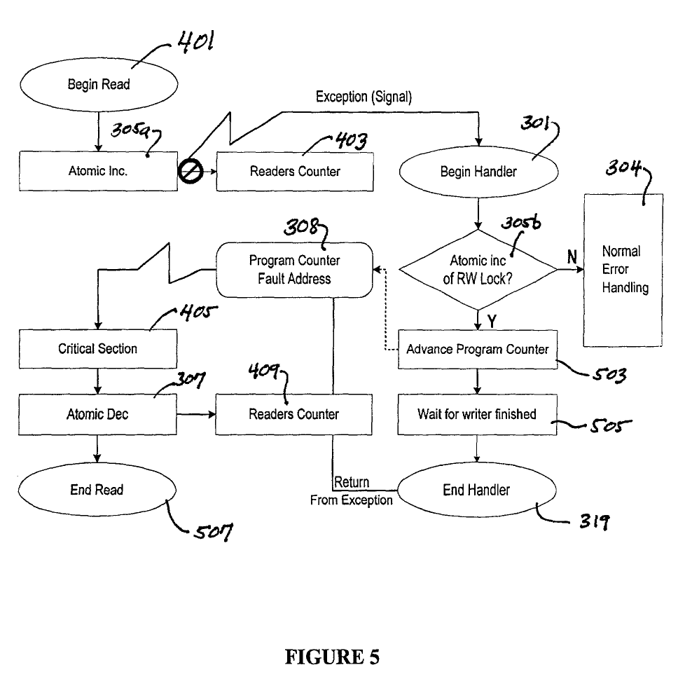

FIG. 5 is a flow chart of the steps required by a read operation 401 when a writer is present. When the reader counter 403 cannot be incremented, an exception is created, and the exception handler routine begins. The exception handler determines if there has been an atomic increment (305b) of the read write (RW) lock, and, if so, advances the program counter (503) and pauses the read process (505). After the write is finished, the reader is awakened by the writer. This occurs by the reader counter being incremented by the writer. The critical section is entered (405), and after the read is completed, the reader counter (409) is atomically decremented (307) and the read process is completed (507).

FIG. 5 illustrates the preferred steps required by a read operation when a writer is in possession of the lock. As shown in FIG. 5, after checking that the fault instruction is an atomic increment, the exception handler executes a full-weight synchronization sequence to acquire the lock as a reader. The lock resides at the fault address. The full-weight synchronization sequence does not need to modify the readers' counter, but it uses other parts of the lock's data which are fully accessible. After the handler returns, the saved execution context is restored and the execution resumes. By default, execution would resume, with the very instruction that caused the fault initially; in this case, the atomic increment of the readers counter. Since the acquisition of the lock is accounted for separately by the full-weight synchronization sequence, and since the counter may still not be accessible, the application code must not attempt to modify the counter again when resuming. For that reason, the handler needs to modify the saved execution context before returning, so that the application code resumes execution past the increment instruction.

FIG. 5 illustrates a situation where the reader has to wait before entering the critical section but not before leaving the critical section. FIG. 5 shows the beginning read 401. The reader process attempts an atomic increment (305a), of the reader's counter (403) but is prevented from doing so by the presence of a writer process. This causes an exception, and begins the exception handler (301). The exception handler checks (305b), for a read-write lock at the fault address found in the saved context (308) and if there is none, calls a normal exception handler (304). Else, before waiting for the writer to finish (505) the exception handler advances (503) the program counter, in the saved context. When the writer process finishes, the exception handler ends (319) and returns from the exception, thereby resuming the program's execution at the modified program counter in the saved context (308). The reader then enters the critical section (405) and, upon leaving the critical section, does an atomic decrement (307) of the reader's counter (409) and ends the read process (507).

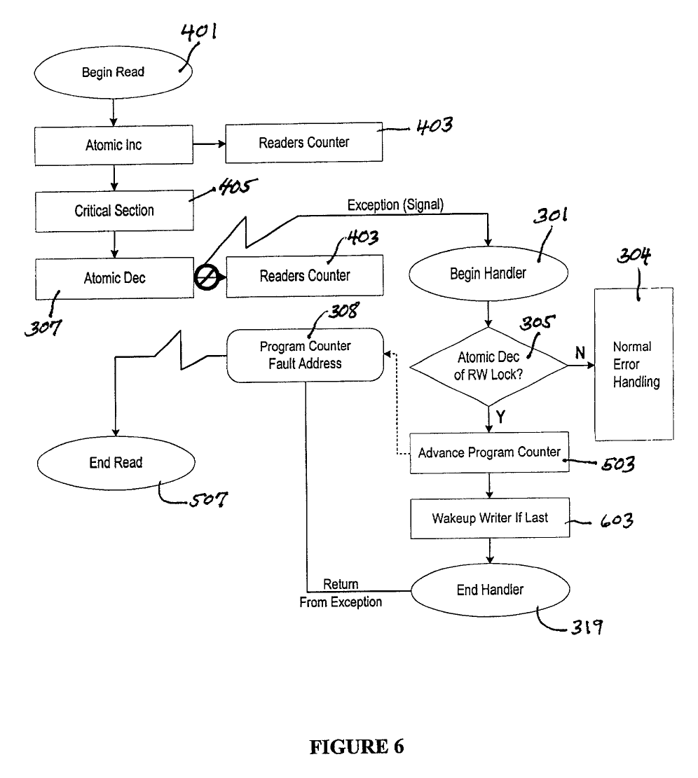

FIG. 6 shows the complementary situation where the reader enters the critical section freely, but has to perform a full-weight synchronization when leaving it, because a writer is waiting. It is possible that the reader may have to perform a full weight synchronization both while entering and leaving the critical section.

FIG. 6 is a flow chart that illustrates the steps required by a read operation when the writer seeks to acquire the read-write lock before the reader releases it. As shown in FIG. 6, the full-weight synchronization comprises decrementing the number of readers (currently stored in the alternate read-write counter location) and waking up the writer, when the counter number has reached zero. Specifically, in FIG. 6, a reader begins a read process (401) and atomically increments (305a), the reader's counter (403). The reader then enters the critical section (405). On leaving the critical section, the read process attempts an atomic decrement (307) of the reader's counter (403). However, because the reader's counter has been made non-writable by a waiting writer, the exception handler (301) is called. The exception handler determines from the saved context (308) if the attempted instruction is an atomic decrement of a read/write lock, and if not, switches to normal exception handling. Else the program counter in the saved context (308) is advanced (503). By decrementing the alternate reader's counter (not shown), the reader determines if it is the last reader. If yes, then the candidate writer is awakened (603). Then the exception handler returns (319) thus resuming the saved context (308) at the end of the read operation (507).

Advantageously, instead of requiring the readers to go through a full weight synchronization, as has been done previously, the invention removes the synchronization overhead from the much more frequent read operations by allowing read operations to enter and leave the critical section as long as no writer is either in the critical section or trying to enter it. All that the readers have to do is to increment a counter when they enter, and decrement it when they leave, so that the number of readers in the critical section can be known at all times. These increments and decrements are atomic operations which can be achieved with a single instruction by all common modern processors. Therefore, when there is no conflict with a writer, the cost of access to the critical section for a reader is exactly two instructions.

Moreover, the readers do not have to expend any overhead to pay attention for a possible writer. They are automatically notified when writers are present. Rather, the writer has to supply the overhead to stop the readers from entering the critical section once a writer is present. The writer's contribution to this is uncomplicated. The writer merely has to remove write permission to the memory area where the counter is located, thereby rendering the counter unmodifiable. As a result, when readers attempt to increment the counter, the readers trigger a memory reference exception instead of changing the counter. This memory reference exception prevents the readers from entering the critical section. The memory reference exception may be captured by an ad hoc exception handler which can use a traditional synchronization method to wait for the writer to be finished.

Before being allowed to enter the critical section, the writer must wait for all currently pending reads to be finished. To do so, the writer copies the reader counter (now rendered read-only by the process) to another memory location as an alternate counter. If the reader counter is not zero, then the writer has to wait for readers to finish. When a pending reader finishes and attempts to decrement the counter, it encounters an exception (since the counter is not writable). The exception handler will decrement the writer's copy of the reader's counter (the alternate counter) and wake up the writer when the writer's copy of the reader's counter has reached zero.

When the writer is finished, it resets the reader counter to a writable state. Thus, a subsequent reader attempting to write to the reader's counter will no longer trigger an exception. The exception handler also atomically increments or decrements the alternate counter as many times as needed to account for the changes the reader counter would have gone through if it had been writable during the writing period, and then wakes up all readers that are waiting for access to the memory.

The invention may use various methods to present readers with an exception condition when entering a critical section that is occupied by a writer. The method described herein to accomplish this is one of a number of several alternatives methods available. One could use any change in the lock object which makes the normal procedures followed by a reader to enter the critical section cause an exception. One of these alternative methods could be to replace a valid pointer used by the reader for entering the critical section with an invalid pointer, provided that the reader uses this approach for entering the critical section.

Other alternative methods would be to use procedures available with the operating system. For example, if the operating system allows applications to map and unmap pages, but does not allow applications change the permissions of pages, then the application can instead create different mappings of the counter page. Readers may always use one of these mappings, while writers use the other. To stop readers and create an exception, writers would merely need to unmap the page used by readers.

The reader-writer lock is preferably a data structure which is more than one page long and is page-aligned. In C++ a special new operator is provided to make sure that the lock is page-aligned. Among other things the first page contains the counter. When a writer wants to gain access to the critical resource, it changes the access permissions of the first page to make it read-only. Under UNIX this is easily done with the mprotect(2) system call. From that point on, no new reader can acquire or release the lock by either incrementing or decrementing the counter. However, many readers may still possess the critical resource.

When a reader attempts to decrement or increment the counter, an exception is triggered (under UNIX this is the Segmentation Violation signal). Normally such an exception terminates the program. However, it is permissible to change this behavior in order to have the program execute a given function instead. With UNIX this is easily done with the sigaction(2) system call. With most modern operating systems, it may be accomplished as well by executing a processors “supervisor” mode. All of the necessary information is available for an exception handler to determine the exact instruction being executed at the time of the exception and the value of all the registers. Because of this information, the cause for the fault can sometimes be fixed, and the execution resumed where it was stopped.

In accordance with the invention, the exception handling code handles only a memory access permission fault and may do the following:

Determine if the fault address is that of a read-write lock counter;

Determine if the fault instruction is an atomic incrementing or decrementing;

If either of the above two conditions is false, then the fault is handled normally. (Else.)

A full weight synchronization is performed directly from the context of the exception handler. Since the fault address is that of the lock's counter, the lock object's address is known;

The instruction pointer saved at the time of the exception is modified in order to skip the atomic incrementing or decrementing instruction, for reasons that will be explained in the following sections;

The saved context is restored (under UNIX the signal handler simply returns) and the program resumes just past the incrementing/decrementing instruction.

To acquire a lock as a writer the following steps, represented as pseudocode, may be carried out.

Acquire the writer mutex (only one writer is allowed);

Arrange so that the counter cannot be modified without creating an exception;

Perform the full weight synchronization;

Execute the critical code;

Perform the full weight synchronization;

Arrange so that the counter can be modified again;

Release the writer mutex.

When the writer wants to acquire the lock, it makes the reader counter read-only as previously described. From that point, until the writer itself makes the reader counter writeable again, the reader counter cannot be incremented, decremented, or otherwise modified. The writer makes a copy of the normal reader's counter in an alternate writable location of the lock's data. It is that alternate location that will be used to keep track of the readers currently owning the lock. The writer is put to “wait” for as long as this alternate counter shows at least one reader, as previously described. This sequence may be performed by using a condition variable.

Until the writer is allowed to enter the critical section and actually leaves it, all readers are forced to go through the full-weight synchronization code. New readers are simply put to “wait” until the writer releases the lock. This waiting is performed by a semaphore which keeps track of the number of “waits.” Readers leaving the critical section decrement the alternate readers counter described previously. When the counter reaches zero, the writer is awakened.

When the writer wakes up, it owns the lock and may perform its critical section.

To release the lock, the writer may first obtain the number of readers waiting. To make sure that these readers are not put to a “wait” state one more time, the writer must give them ownership of the lock at that time, before letting a potential next writer acquire the lock. To do this the normal readers counter must be made to account for these new readers. In addition the current value of the normal counter will be wrong since it accounts for readers which have since left the critical section through the full-weight synchronization code. The new correct value of the counter actually corresponds to the number of new readers being awakened. However, the writer cannot just change the value in the readers counter by writing to it because as soon as it is made writable for that purpose, it may be accessed in parallel by new incoming readers. Therefore, the writer preferably performs incremental corrections to the readers counter as follows. First, the correction to be applied to the counter is computed. This is the difference between the counter's current value and the correct value based upon the number of new incoming readers. Then the counter is made writable, and is adjusted to the correct value by performing as many atomic increment or decrement instructions as needed to complete the correction. During this time the counter is not accurate, but it is not important since the writer still holds the writer mutex. Therefore, no other writer may attempt to enter the critical section. Once all these operations have been performed, the writer releases the writers mutex, thus completing the process.

The foregoing is but one way of dealing with the question of resetting the readers counter. Another possible way involves changing the counter through a separate memory mapping before permitting it to be modified by readers.

It should be noted that the readers semaphore, the alternate counter, and the writers condition variable are protected by a dedicated mutex which has to be released when sleeping. This is the normal behavior of the standard synchronization tools used, and dictates some implementation precautions which would be well know for one skilled in the art. Therefore these implementation details are not described here.

The method and system of the invention described herein substantially reduce the “machine time” and “machine operation” cost of conflict-less read access, albeit at the expense of other operations like conflict-less write access or conflicting accesses. However, the invention is highly beneficial to all applications and processes which exhibit a high probability of conflict-less read access relative to other types of accesses, and it works best when write accesses are infrequent. The invention is particularly useful with modern operating systems used to run high-volume, high-throughput, data manipulation applications, i.e., those which have a use for a reader-writer lock, utilize paged virtual memory and provide page-level control to applications;

The invention is also particularly useful when running on an operating system that supports both page-based virtual memory and page-level control of memory layout by applications. Preferred operating systems are those that support application-defined exception handlers, and the availability to the application of atomic increment and decrement instructions. Moreover, individual applications which run on the system and method described herein preferably have code, generally processor-dependent code, for describing the atomic increment and decrement instructions, unless the compiler supports the atomic increment and atomic decrement abstractions. Moreover, the invention works best with application-wide or, at least, thread-wide interception of memory access exceptions. If other parts of the code need to intercept these exceptions for other reasons, the various mechanisms can be readily determined from the foregoing which need to cooperate. Processor-dependent code may need to analyze the reason for a memory access exception and decide what action to take. Preferably, the operating systems should also provide applications with application-defined exception handling mechanisms and access to enough information to analyze the exception. Exemplary operating systems include Linux, Solaris and most Unix variants aiming at POSIX conformance, and Windows NT.

The processors used to run these operating systems and applications support the necessary atomic increment and decrement instructions or similar enough variants. Namely, these processors include the Intel x86 family, most PowerPC variations, as well as Sparc variations.

The machine-dependent source code to generate these instructions may advantageously be only one-line long and is straightforward. The program can be easily ported to other major platforms. In most instances, the machine-dependent code for analyzing exceptions may be a few lines long. Thus, the program can be easily ported to other major platforms.

While the invention has been described herein with respect to certain preferred embodiments, it will be understood that these are exemplary and that the method and system of the invention can be implemented in a variety of other ways, the scope of which is defined by the appended claims. A key feature is to use a very lightweight synchronization, enough to keep track of readers, but not enough to perform exclusion with writers, and to use an exception-based mechanism to force readers to use a different synchronization method when a writer wants to compete for the lock.

We claim:

1. A method of synchronizing writer and reader operations on an object protected by a lock comprising incrementing a counter upon a reader accessing the object protected by the lock, and decrementing the counter upon the reader leaving the object; setting the counter upon a writer accessing the object so that attempts to increment and decrement the counter cause an exception; permitting the writer to access the object upon the counter having a count of zero; triggering an exception upon a reader attempting to read the object while accessed by the writer; capturing the exception by an exception handler which causes the reader to wait until access by the writer is finished; and resetting the counter to be writable upon the writer finishing access to the object.

2. The method of claim 1, wherein the object is a memory and the operations comprise read and write operations.

3. The method of claim 2 wherein setting the counter to cause an exception comprises removing write permission to the counter.

4. The method of claim 3 further comprising restoring write permission to the counter upon the writer finishing access to the memory.

5. The method of claim 1 further comprising causing the writer accessing the object to wait for access until all readers reading the object are finished.

6. The method of claim 5 wherein said permitting the writer to access the object upon the counter having a count of zero comprises waking up the writer upon all said readers accessing the object being finished.

7. A reader-writer lock method for controlling access to a memory by readers and writers comprising incrementing a counter by a reader accessing the memory and decrementing the counter by a reader finishing access to the memory, the counter maintaining a count of the number of readers accessing the memory; resetting the counter to be non-modifiable upon a writer attempting to access the memory; establishing an alternative counter having a count corresponding to the number of readers at the time of attempted access by a writer; decrementing the alternative counter as each reader finishes access; permitting the writer access to the memory upon the alternative counter reaching a count of zero; and returning said first-mentioned counter to a modifiable state upon the writer finishing access to the memory.

8. The method of claim 7, wherein decrementing said alternative counter comprises invoking an exception handler to decrement the alternative counter upon a reader finishing access to the memory and producing a decrement instruction.

9. The method of claim 7 further comprising maintaining a queue of readers attempting to access the memory while the memory is in said non-modifiable state, and remapping said number of waiting readers to said first-mentioned counter upon returning said first-mentioned counter to the modifiable state.

10. The method of claim 8 further comprising permitting simultaneous access to the memory by multiple readers in the absence of a writer attempting to access the memory.

11. In a computer system having one or more resource access processes including a reader process and a writer process, an operating system, and an application program, where one or both of said operating system and said application program support page-based memory accesses and page-level control of memory layout, and wherein said computer system is controlled by one of said operating system and said application program to resolve reader and writer access conflicts of the memory, a method for controlling access to the memory comprising providing in memory a counter which maintains a count of a number of readers attempting to access the memory, said maintaining comprises incrementing the counter upon a reader attempting to access the memory and decrementing the counter upon a reader leaving the memory; removing write permission to the counter upon a writer requesting access to the memory and mapping the counter to an alternative counter; incrementing the alternative counter upon readers attempting to access the memory while the memory has write permission removed; decrementing the first-mentioned counter upon readers leaving the memory; granting access to the writer upon the first-mentioned counter reaching a count of zero; and remapping the count in the alternative counter corresponding to waiting readers and the first-mentioned counter.

12. The method of claim 11, wherein at least one or both of the operating system and the application program support atomic increment and decrement operations.

13. The method of claim 11, wherein at least one or both of the operating system and the application program support interception of memory access exceptions.

14. The method of claim 11 wherein at least one or both of the operating system and the application program support thread-wide interception of memory access exceptions.

15. The system of claim 11, wherein at least one or both of the operating system and the application program support application wide interception of memory access exceptions.

16. The system of claim 11, wherein the application program supports application defined exception handling.
